(19) United States
(12) Patent Application Publication
(10) Pub. No.: US 2026/0243278 A1
(43) Pub. Date: Aug. 20, 2026

(54) SELF-ANCHORING BURROWING EVERTING ROBOT

(71) Applicant: The Regents of the University of California, Oakland, CA (US)

(72) Inventors: Nicholas D. Naclerio, Portola Valley, CA (US); Elliot W. Hawkes, Goleta, CA (US)

(21) Appl. No.: 18/872,199

(22) PCT Filed: Jun. 7, 2023
(86) PCT No.: PCT/US2023/068050

§ 371 Date: Dec. 5, 2024

Related U.S. Application Data
(60) Provisional application No. 63/352,385, filed on Jun. 15, 2022.

(51) Int. Cl. F15B 15/10; E21B 7/26

(52) U.S. Cl. CPC F15B 15/103; E21B 7/26; F15B 2215/305

(57) ABSTRACT

A self-anchoring everting robot includes a flexible body tube that accepts fluid and can be everted via pressure to provide tip growth and one or more of root hairs on the body tube that model plant roots, radial branch extensions that model plant root systems, and radial swelling that models plant root growth. Root hairs can be formed to be biased against pull out forces and have a substantial thickness compared to the main body.

### PRIORITY CLAIM AND REFERENCE TO RELATED APPLICATION

The application claims priority under 35 U.S.C. § 119 and all applicable statutes and treaties from prior U.S. provisional application Ser. No. 63/352,385, which was filed Jun. 15, 2022.

### STATEMENT OF GOVERNMENT INTEREST

This invention was made with government support under grant number 80NSSC21K0073 awarded by the National Aeronautics and Space Administration. The government has certain rights in the invention.

### FIELD

A field of the invention is vine robot devices that have everting bodies and grow with pressure. Example applications of the invention include deployment of vine robots in environments with reduced gravity, underwater, and subsurface deployment. Specific applications for the invention will be found in agriculture, botany, construction, geotechnical engineering, civil engineering, and space exploration.

### BACKGROUND

Hawkes et al. US Patent Publication US2019/0217908, Published Jul. 18, 2019 describes a growth robot. The growth robot has a thin-walled, hollow, pressurized, compliant body that elongates the body by everting from its tip new wall material that is stored inside the body and controls the shape of the body by actively controlling the relative lengths of the wall material along opposing sides of the body. Relative lengths of the wall material along opposing sides of the body can be controlled by shortening the length of the wall material on the side facing the inside of a turn by using contracting artificial muscles mounted along the length of the body. Relative lengths of the wall material along opposing sides of the body can also be controlled by lengthening the wall material on the side facing the outside of a turn, by releasing pinches in the wall material, or by actively softening the material so that the body lengthens due to the internal pressure. Relative lengths of the wall material along opposing sides of the body can also be controlled by actively restraining the length of the wall material on the side facing the inside of a turn while allowing the wall material on the outside of the turn to lengthen.

An advancement of the growth robot technology by Hawkes et al. is provided in a soft robotic device that has an apical extension and includes fluid emission for burrowing and cleaning. Such soft robots are able to burrow through sand or dirt, in a manner analogous to a plant root. The robot extends apically through eversion, while emitting fluid from the tip that fluidizes sand and soil making it possible to grow underground. That advance is disclosed in PCT/US2019/50998, filed Sep. 13, 2019 and in the published paper by Hawkes et al., entitled “Soft Robotic Burrowing Device with Tip-Extension and Granular Fluidization.

One difficulty with prior burrowing robots relates to a lack of reaction force to enable tip extension/further eversion and growth into the medium which into which the robot is burrowing. For initial burrowing, the pump/device being used to inflate the robot provides some reaction force, but this has limits defined by the medium conditions, friction conditions and the softness of the robot body.

Sadeghi et al, “Robotic Mechanism for Soil Penetration Inspired by Plant Root,” 2013 IEEE International Conference on Robotics and Automation, Karlsruhe, Germany, May 6-10, 2013, describes a robot having a hollow rigid cylindrical shaft, a soft and flexible skin, and a system to pull the skin to imitate sloughing behavior. The skin is used to displace soil and is retracted upward by the pull system. The skin movement aids in intrusion into glass beads, but the device does not demonstrate full self-anchoring where the skin becomes stationary relative to the surrounding medium. The forces required for penetration of the shaft and retraction of the skin are significant due to friction and the rigid shaft adds mass and limits the length that the device can penetrate. Tendons and a ring are used to pull the skin upward, which adds to device diameter and required forces. Artificial hairs are described as being made of thermal glue and placed on part of the skin to provide an initial anchorage to penetrate the soil.

Naclerio, Nicholas D., Andras Karsai, Mason Murray-Cooper, Yasemin Ozkan-Aydin, Enes Aydin, Daniel I. Goldman, and Elliot W. Hawkes. “Controlling subterranean forces enables a fast, steerable, burrowing soft robot.” Science Robotics 6, no. 55(2021) disclosed self-anchoring with a smooth, everting tube in horizontal growth. There is no description of how to limit required forces for non-horizontal growth. Chen, Yuyan, Ali Khosravi, Alejandro Martinez, and Jason DeJong. “Modeling the self-penetration process of a bio-inspired probe in granular soils.” Bioinspiration & Biomimetics 16, no. 4(2021): 046012 discussed radial expansion of everting robots. No physical robot features were described to achieve radial expansion in a device in a granular media.

An everting device with hairs found that increasing hair density reduced rejection force. See, Sadeghi, Ali, Alice Tonazzini, Liyana Popova, and Barbara Mazzolai. “Robotic mechanism for soil penetration inspired by plant root.” In 2013 IEEE international conference on robotics and automation, pp. 3457-3462. IEEE, 2013. The artificial hairs in Sadeghi et al. 2013 are short (length of ⅓ body diameter) simple cylindrical protrusions and are not designed to efficiently fold away as the device everts because the body is not under hydrostatic pressure forces.

### SUMMARY OF THE INVENTION

A preferred embodiment provides a self-anchoring everting robot includes a flexible body tube that accepts fluid and can be everted via pressure to provide tip growth and one or more of root hairs on the body tube that model plant roots, radial branch extensions that model plant root systems, and radial swelling that models plant root growth, Root hairs can be formed to be biased against pull out forces and have a substantial thickness compared to the main body.

### BRIEF DESCRIPTION OF THE DRAWINGS

FIGS. 1A-1E show preferred self-anchoring everting robots with root hairs, a radial expending body and radial branch extenions;

FIG. 2 shows data from discreet element simulations measuring the maximum pull-out force on 8 mm diameter anchors with 5 mm long, 3 mm wide root hairs in 1 mm diameter poppy seeds;

FIG. 3 is an image of two experimental everting robots with different root hairs;

FIG. 4 shows a body of an experimental robot with radial branch extensions during formation (prior to sealing the body tube);

FIGS. 5A-5B shows bodies of experimental robots with radial branches;

FIG. 6 plots data of effects of branching and insertion angle;

FIG. 7 is data that shows that radial expansion increases pull out force; and

FIG. 8 shows an example deployment method for preferred preferred self-anchoring everting robots of the invention.

### DESCRIPTION OF THE PREFERRED EMBODIMENTS

A preferred self-anchoring robot has a flexible body tube that accepts fluid and can be everted via pressure to provide tip growth and one or more of root hairs on the body tube that model plant roots, radial branch extensions that model plant root systems, and radial swelling that models plant root growth. Self-anchoring robots of the invention can extend, penetrate materials, grip the materials with roots, radial extension and/or radial swelling solely based upon fluid pressure into the flexible body tube. Other than fluid pressure, no force need be applied to achieve penetration into a medium or to create eversion.

The root hairs in preferred embodiments are arranged to model plant roots. The root hairs are sized and arranged to engage surrounding medium in a manner that provides anchoring force and that reduces slippage of the robot body as it continues to grow in the medium. The root hairs can reduce the reaction force at the surface to zero once the robot body has sufficiently self-anchored into the medium with the root hairs. The root hairs are formed of material that permits the eversion. The root hairs can be distributed along an entire length of the flexible body and around an entire circumference, to model natural growth of plant roots.

Preferred radial branch extensions also model plant root systems. The radial branch extensions are arranged to engage surrounding medium in a manner that provides anchoring force that reduces slippage of the robot body as it continues to grow in the medium. The radial branch extensions can reduce the reaction force at the surface to zero once the robot body has sufficiently self-anchored into the medium with the root hairs. The radial branch extensions are preferably arranged occasionally and semi-randomly along the circumference and length of the flexible body, to model natural growth of plant roots.

Radial expansion is also included in preferred embodiment everting robots, also to model plant root growth. After burrowing to some depth, the device, its branches, or sections of it, expand or swell radially thereby increasing their diameter. The radial expansion increases anchoring force by pressing the body material into the surrounding medium, and pressing root hairs into surrounding material.

A preferred everting robot is self-anchoring robot with a thin flexible body that uses two or more anchoring techniques including: root hairs that model plant roots, radial branch extensions that model plant root systems, and radial expansion that models plant root growth. Combinations of these features engage surrounding medium in a manner that provides anchoring force that reduces slippage of the robot body as it continues to grow in the medium. The amount of growth/burrowing/extension with multiple features reduces the amount of growth/burrowing/extension needed to reduce the reaction force at the surface to zero compared to using either feature on its own.

The ability of present everting self-anchoring robots to model plant roots provides an extremely efficient burrowing ability. Roots branch to increase surface area and the volume of recruited soil or other medium. Small root hairs locally anchor themselves against reaction forces. Radial growth increases lateral strength while decreasing soil strength at the tip and thus enabling easier root tip extension. These features are difficult to implement in traditional pilings or burrowing devices but are made possible by tip extension in present everting self-anchoring robots.

Preferred robots can have multi-layer high-pressure bodies for burrowing. A preferred high pressure burrowing everting robot has a body of composed of a durable composite fabric with a TPU (Thermoplastic polyurethane) bladder. In experiments, Dyneema® composite fabric was used as a durable composite. That fabric is a laminate of polyester film and ultra-high-molecular-weight polyethylene (UHMWPE) fibers. UHMWPE is used in braided fishing line and gives this fabric a much higher strength to weight ratio than woven nylon fabric.

Other experimental robot body tubes were formed of Kevlar®, which is a heat-resistant and strong synthetic fiber. Specifically, it is a light, polyarylamide plastic fabric, which has a high tensile strength. A woven Kevlar® tube was used to form the body with a TPU bladder. A 380 μm thick TPU tube is used inside a 15 mm diameter, 2 mm thick woven Kevlar tube. 2 cm diameter tubes with this design withstood over 6 MPa of pressure.

Preferred embodiments of the invention will now be discussed with respect to experiments and drawings. Broader aspects of the invention will be understood by artisans in view of the general knowledge in the art and the description of the experiments that follows.

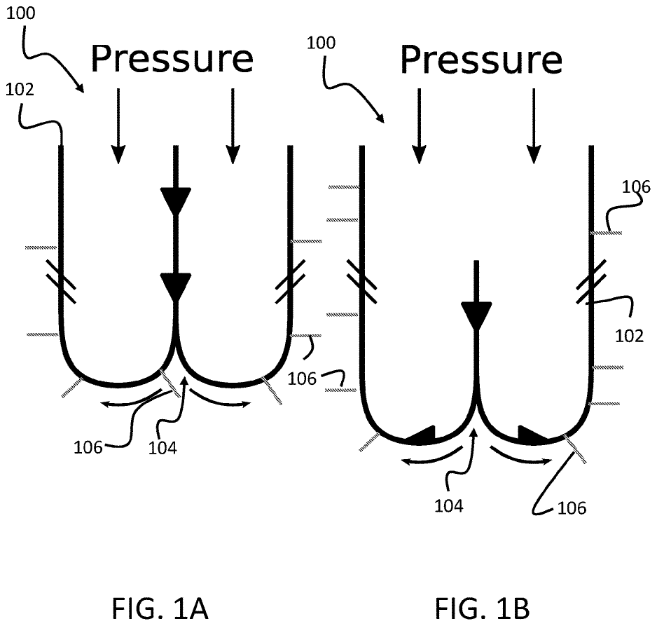

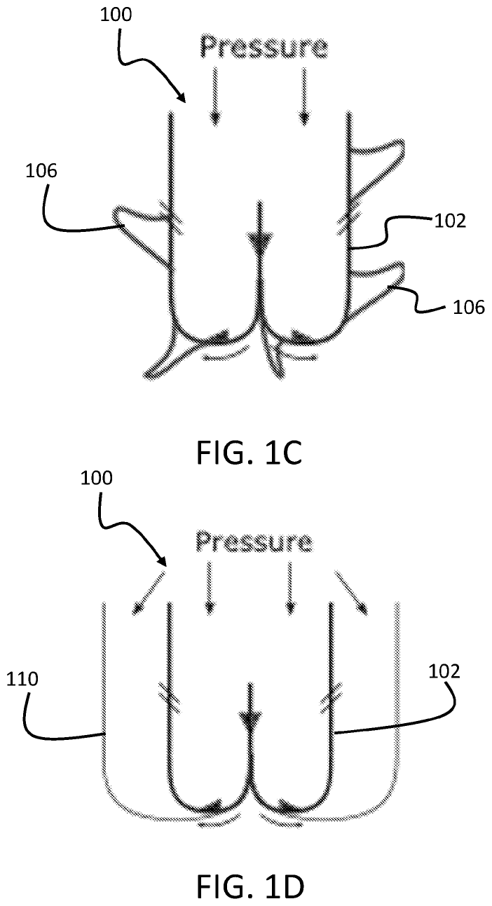

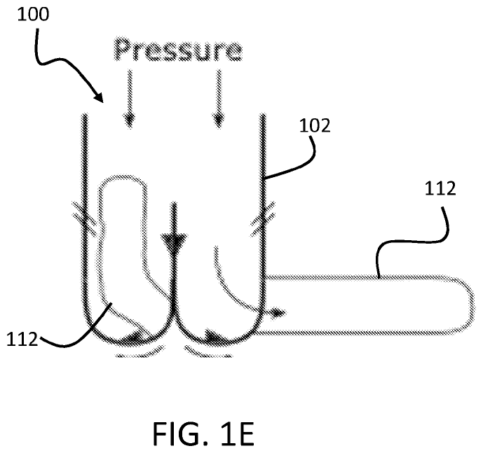

FIGS. 1A and 1B show a preferred self-anchoring everting robot 100 have a flexible body tube 102 that accepts fluid pressure (gas or liquid) and can be everted via pressure to provide tip 104 growth. In the robot 100, root hairs 106 are distributed on the body tube 102 to model root hairs on natural plant roots. The root hairs 106 are held flat in the inverted position of the body tube 102 and extend away from the body tube 102 after eversion to grip and provide friction with a surrounding environment. FIGS. 1A and 1B show the robot 100 in respective less and more everted positions, and the more everted position in FIG. 1B reveals more root hairs 106. It is preferable that root hairs 106 be distributed along an entire axial length of the body tube 102 such that as the tube 102 everts and the tip 104 advances, additional root hairs 106 are located near the advancing tip 104 to provide grip and friction that allows the tip 104 to advance more easily because the portion of the already everted body 102 near the tip resists sliding in the surrounding medium due to the root hairs. FIG. 1C shows that the root hairs 106 can be symmetric or resiliently shaped to be biased against the direction of robot pull-out. Resiliently shaped hairs 106 can have a thicker base and be molded or otherwise formed and attached to return to shape biased against direction of pull-out (toward a proximal direction of the robot 100) when released from being folded during eversion. In the inverted position of the robot, the shaped hairs can fold or compress to fit inside the inverted body. The hook-like shape of the root hairs 106 is a preferred resilient shape. Root hairs 106 can also be fabricated by 3D printing, casting, or working other polymers and elastic metals such as super-elastic nickel-titanium alloys. The root hairs 106 can have substantial diameters compared to the main body (e.g. ½ or more of the everted diameter of the body 102). The root hairs 106 of FIG. 1C can be formed as flexible or hinged flaps that fold away inside the everting body 102 in its everted state. As the body 102 everts, the protrusions (hairs 106) spring outward to create a larger surface to help anchor the robot The hair 106 can be perpendicular to the body 102 and can also be designed to be directionally biased to better hold the soil against pull-out forces, as seen in FIG. 1C.

FIG. 1D shows an embodiment that includes a radially expanding body 110. The radially extending body 110 is similar to the main everting body 102, but with a larger diameter, and surrounds the main everting body 102 in the everted position. After the main body has everted, the radially expanding body can be inflated via a separate fluid path to increase the outer diameter of the robot 100. The radially expanding body 110 can also extend the length of the main everting body 102, or only a segment of it, connected with a tube like a blood pressure cuff. To only cover a finite length the expanding body 110 is sealed to the main body 102 at either end, and can be connected to a separate fluid supply tube.

FIG. 1E shows a preferred robot 100 with radial branch extensions 112. The radial branch extensions can be formed as part of the main body 102 at various radial and axial locations along the main body 102. As the main body 102 everts to release a radial branch extension 112, the extension then everts and grows via fluid pressure while the main body 102 continues to evert. The radial branch extensions 112 can themselves have additional “child” extensions, which extend in the same manner from the radial branch extension as it everts as does the radial branch extension from the main body.

The features of FIGS. 1A-1E can be combined together, i. e, the robot can have root hairs 106, including shaped and thick root hairs as well as thinner root hairs, can have radial extensions 112 and can have a radially extending body 110. Root hairs 106 and radial extension 112 can be formed on an outer everted surface of the radially extending body 110. The robots of FIGS. 1A-1E achieve plant-like growth by tip extension, which reduces sliding friction along sides of the body 102 and allows squeezing between tight obstacles. The body 102 can be a thin-walled tubular body of inelastic airtight fabric, inverted back inside itself. When pressurized, the tube 102 everts, passing new material out of the tip 104 to extend. The robot is retracted by pulling back on the new material to reinvert. The eversion and inversion basic operations have been previously demonstrated. See, e.g., Naclerio, Nicholas D., Andras Karsai, Mason Murray-Cooper, Yasemin Ozkan-Aydin, Enes Aydin, Daniel I. Goldman, and Elliot W. Hawkes. “Controlling subterranean forces enables a fast, steerable, burrowing soft robot.” Science Robotics 6, no. 55(2021). However, the present root hairs, branch extensions and/or radially expanding bodies provide more efficient eversion and extension and also overcome speed and scalability limitations of designs that grow through additive manufacturing. See, Sadeghi, Ali, Alessio Mondini, and Barbara Mazzolai. “Toward self-growing soft robots inspired by plant roots and based on additive manufacturing technologies.” Soft robotics 4, no. 3(2017): 211-223.

### Experimental Plant-Like Self-Anchoring Everting Robots

Self-anchoring everting robots consistent with FIGS. 1A-1D have been fabricated and tested. Aspects of experimental self-anchoring everting robots demonstrate additional preferred features of the invention and provide demonstration of performance advantages.

### Tip Extension

Tip extension allows friction and traction forces to counter restive forces at the tip of a plant or burrowing device, enabling self-anchoring. Preferred robots achieve tip-extension with a flexible, airtight tube inverted inside itself such that when pressurized it everts, passing new material out its tip to extend. The device can be retracted by pulling back on its internal material to re-invert itself.

Preferred example robots include a body composed of an airtight film (i.e. low density polyethylene), fabric (i.e. thermoplastic polyurethane or silicone coated ripstop nylon), or airtight composite material (i.e. Dyneema) with or without an additional airtight bladder for robustness (i.e. thermoplastic polyurethane).

Body tubes can be constructed from flat sheets of material by rolling and bonding them into a tube with a lap joint joined by heat welding, glue (i.e. room-temperature-vulcanizing silicone epoxy), transfer tape (i.e. 3M pressure sensitive transfer tape), or tape.

A prototype was constructed as follows. The outer layer was composed of 0.51 oz Dyneema Composite Fabric, a high-strength, 40 micrometer thick, laminate of polyester film and ultra-high-molecular-weight polyethlyne fibers. Tubes were formed by rolling the Dyneema fabric into a tube and adhering it with a lap joint using a 13 mm wide, 50 micrometer thick strip of acrylic pressure sensitive adhesive (PSA) transfer tape (3M F9460PC). The bladder was composed of a 50 micrometer thick thermoplastic polyurethane film (American Polyfilm) heat sealed into a tube.

### Root Hair Protrusions

Root hairs increase anchoring force, as observed in our experiments. This is similar to plant behavior, for example the anchoring force of wild type maize is over five times higher than a hairless mutant, depending on soil density. See, Bengough, A. Glyn, Kenneth Loades, and Blair M. Mckenzie. “Root hairs aid soil penetration by anchoring the root surface to pore walls.” Journal of Experimental Botany 67, no. 4 (2016): 1071-1078. Particle image tracking showed that the wild type recruited more surrounding soil than the hairless type, increasing its force.

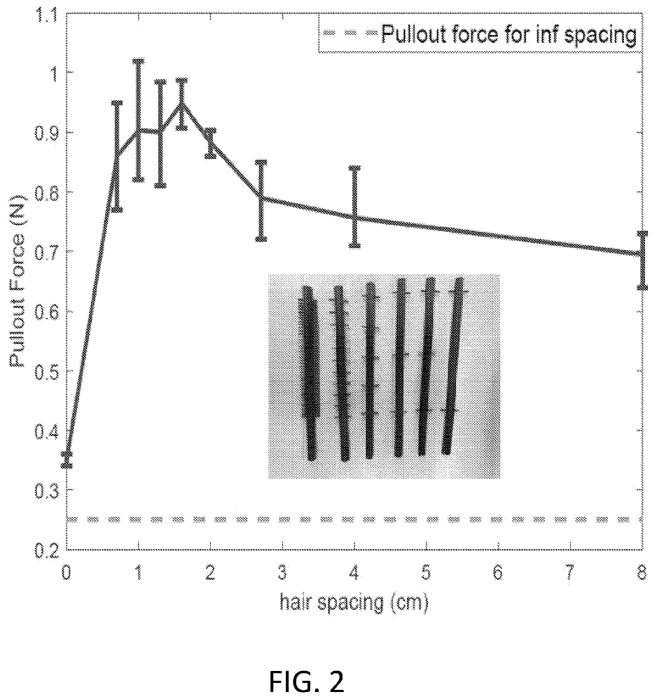

FIG. 2 shows data from discreet element simulations measuring the maximum pull-out force on 8 mm diameter anchors with 5 mm long, 3 mm wide root hairs in 1 mm diameter poppy seeds (little black seeds on a poppy seed bagel. They are useful for simulations because they are about 1 mm and are lightweight). The data shows that there is an optimal hair spacing of about 10 mm. The optimal spacing for hair spacing will depend on anchor diameter, hair size and stiffness, and the physical properties of the surrounding medium.

As the anchoring device grows in to a medium, at a certain depth depending on soil strength, anchor diameter, and hair size, increased pull out force, and reduced reaction force. In each case, the reaction force was reduced to near zero at a depth that was dependent on hair density. Once the device passed this depth, the device is considered “self-anchored,” meaning that the anchor itself provides enough anchoring force to fully counter the resistive forces of the sand or soil at its tip. At this point no external reaction force from an operator or device at the surface is needed for the device to burrow deeper,

The hair-like protrusions can be constructed in a variety of ways out of films and plastics. Simple, symmetric protrusions must be short and flexible enough to fit inside the everted tube, elastic enough to deploy as the tube everts, and stiff enough to hold a load to help self-anchoring. Flaps that have a biased orientation to better anchor against anchor pull-out can be made in a hinged design so that the flap can fold flat inside the everting body and spring outward as the main body everts.

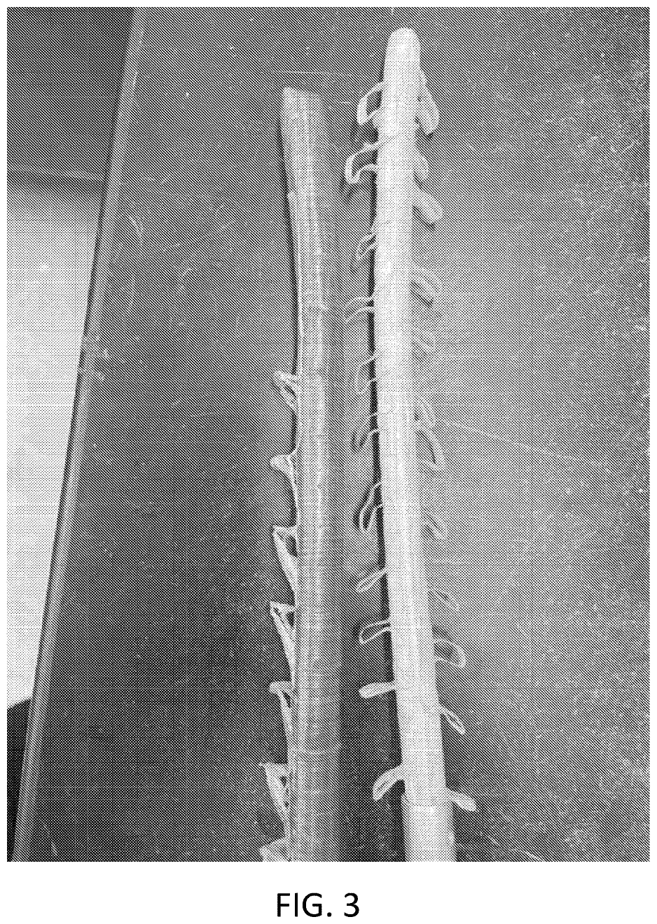

FIG. 3 shows two experimental everting robots with different root hairs. The left image shows an everting robot with Dyneema flaps as root hairs and the right image an everting robot with plastic flap root hairs.

In an experimental robot, root hairs were construct of 135 micrometer thick polyester plastic film folded into a ⊥ shape and attached to the main body with PSA tape and Dyneema fabric.

Root hairs were constructed out of Dyneema fabric that was cut and folded in a pattern such that it created a series of ⊥ shapes and attached to the main body with PSA tape.

Root hairs were constructed by combining a cut and folded pattern of Dyneema fabric with small flaps of either 135 micrometer thick polyester plastic film, or 125 micrometer thick thermoplastic polyurethane film folded into an L shape and inserted inside flaps in the Dyneema fabric.

### Radial Branch Extensions

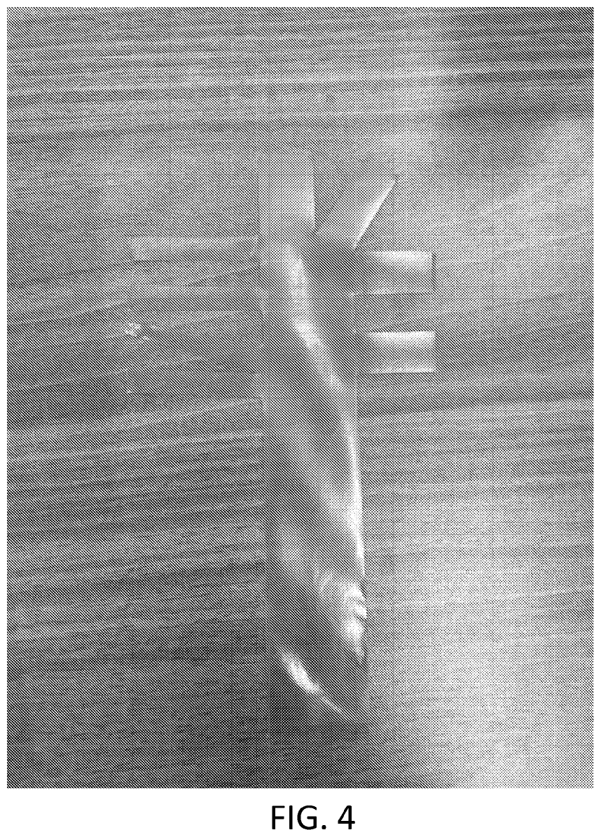

FIG. 4 shows a body of an experimental robot during formation (prior to sealing the body tube). Experiments showed that radial branches, hierarchical branches and branching angle increase projected surface area. Arbitrary branches can be formed by cutting and heat welding thermoplastic polymer film, including main radial branches and child branches (smaller branches extending from another branch). The FIG. 4 fabrication produces unitary bodies, the main body and branches being formed from a single, unitary and shaped piece of material. In addition to hierarchically, branches can be formed in a bundled fashion, where all branches start at the same location, and do not need to be directly spliced together.

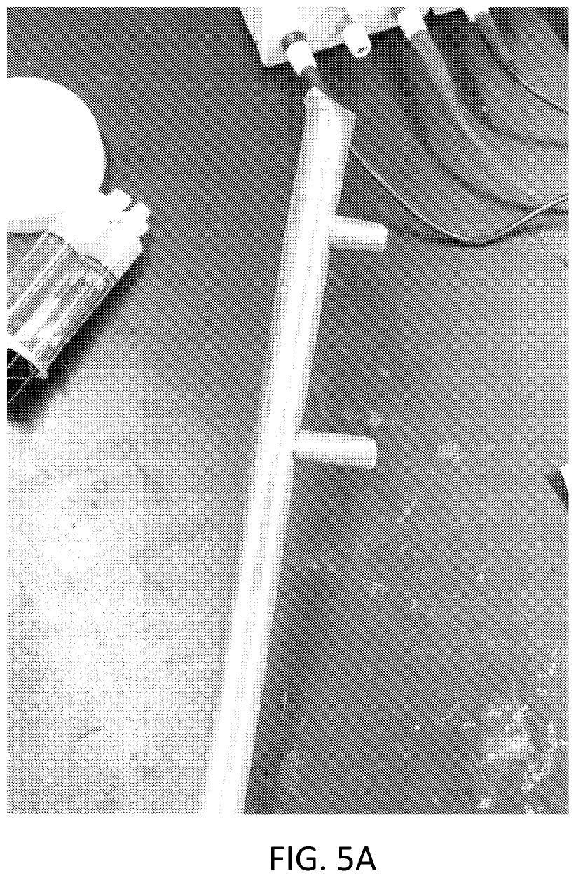

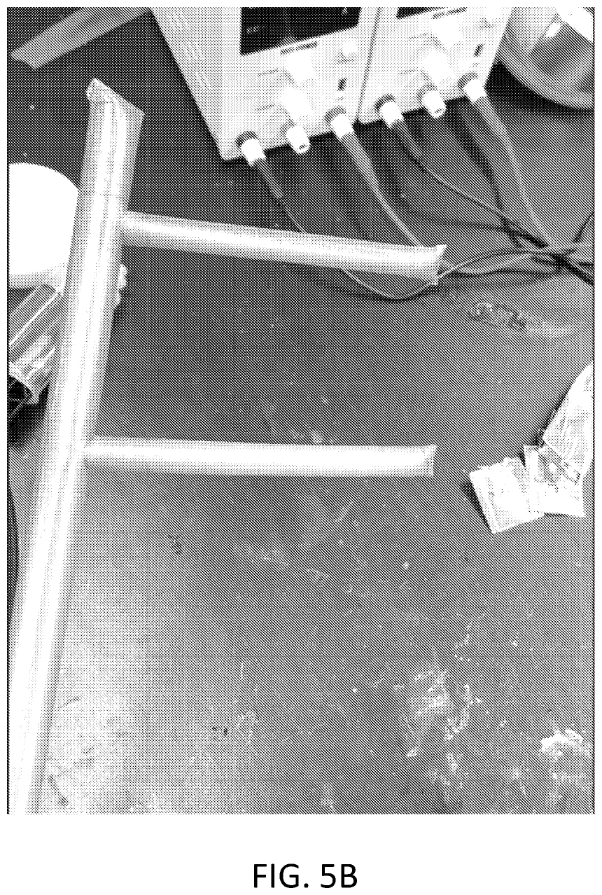

FIGS. 5A-5B shows bodies of experimental robots with radial branches. The branches in this instance are formed by joining separate main body and radial branch tubes together.

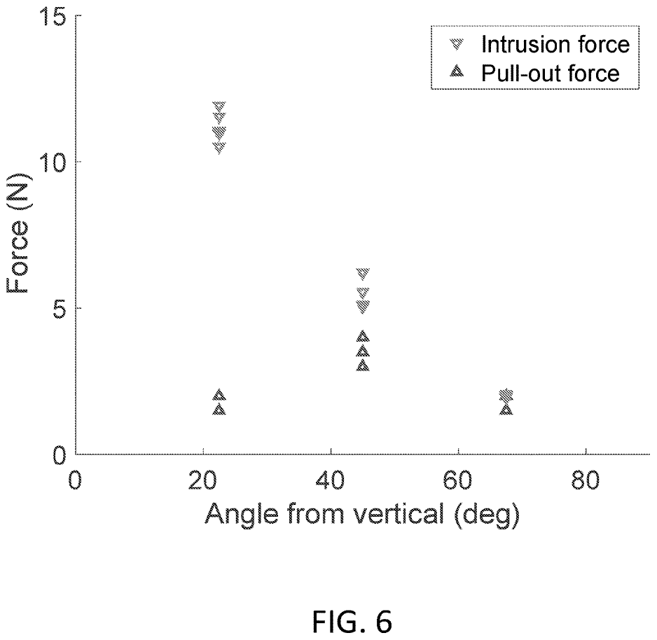

FIG. 6 plots data of effects of branching and insertion angle. Insertion at a shallow angle requires less intrusion force but may generate less pull-out force. However, the ratio of pull-out force to intrusion force is higher for shallower angles. The results show that at more vertical angles, the insertion force is highest, and at horizontal angles it is lowest. The pull-out force is maximized closer to 45 degrees. Combining these results, angles closer to horizontal have the highest pull-out to insertion force ratio, but lowest actual pull-out force.

### Radial Swelling

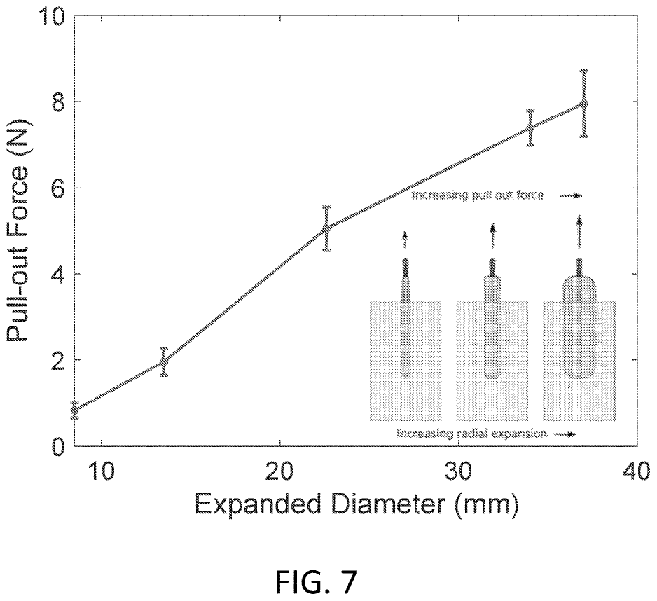

FIG. 7 shows that radial expansion increases pull out force. Expansion can be achieved pneumatically by inflating a buried tube or body. The tube can be on a rigid rod inserted into the ground, or around a device that has grown into the ground using tip-extension. Prototypes were made of Dyneema fabric bonded into a tube. Devices that can first grow, and then expand are constructed of one tube inside the other, where the inner tube has a smaller diameter than the outer one. Both tubes are inverted together, then if only in the inner one is inflated the whole body will extend from its tip. Once it has reached its full length, the outer tube can be independently inflated to expand the device.

### Deployment Methods

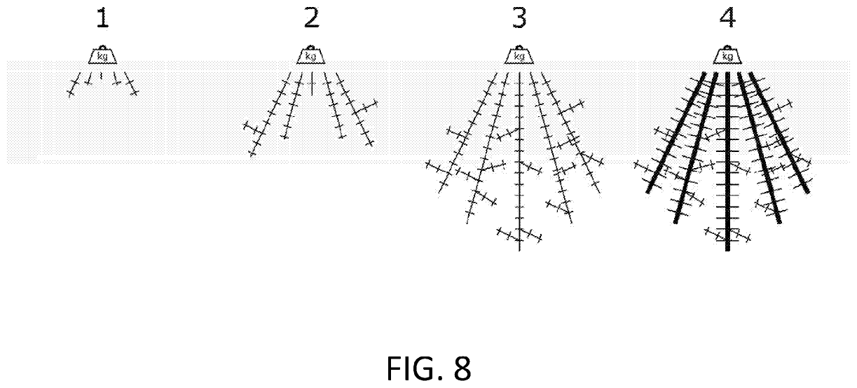

FIG. 8 shows an example deployment method. Four deployment steps are shown. Shallow hairy branches deploy first, followed by more vertical ones, radial branches and finally use radial swelling to increase anchoring. To maximize self-anchoring, a preferred method maximizes anchoring force as a function of reaction force. The method sequentially inserts angled tip-extending devices with root hairs, branches, and finally radial expansion.

### EXAMPLE APPLICATIONS

An important application of the present self-anchoring burrowing everting robots is to burrow into the ground or another material with little to no external reaction force. This would be useful in environments where reaction forces are difficult to produce such as remote locations, reduced gravity, and underwater. The self-anchoring device could be used to 1) deploy sensors for uses such as in agriculture, climate, and planetary sciences. 2) Anchor structures such as rovers, cranes, excavators, habitats, telescopes, and submarines. 3) Access subsurface objects of scientific or monetary interest. The device can be deployed permanently by filling it with a solid such as foam, concrete, dirt, or regolith. The device can be deployed temporarily by retracting it. The device can be used in conjunction with other force reduction and earth moving mechanisms such as drills, vibration, fluidization, and ice melting.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A self-anchoring everting robot comprising a flexible body tube that accepts fluid and can be everted via pressure to provide tip growth and one or more of root hairs on the body tube that model plant roots, radial branch extensions that model plant root systems, and radial swelling that models plant root growth.

2. The self-anchoring robot of claim 1, comprising a combination of two or three of the root hairs, radial swelling and radial branch extensions.

3. The self-anchoring robot of claim 1, wherein the root hairs comprise plastic film folded into a substantial ⊥ shape and adhered to the body tube to be external when everted.

4. The self-anchoring robot of claim 3, wherein the root hairs are adhered by taping, adhesive or heat treatment.

5. The self-anchoring robot of claim 1, wherein the body formed of composite high pressure skin and air tight bladder arranged to permit pressure to evert the high pressure skin.

6. The self-anchoring robot of claim 5, wherein the high pressure skin is a durable composite fabric.

7. The self-anchoring robot of claim 6, wherein the bladder is a thermoplastic material.

8. The self-anchoring robot of claim 6, wherein the durable composite is a fabric laminate of polyester film and ultra-high-molecular-weight polyethylene (UHMWPE) fibers.

9. The self-anchoring robot of claim 6, wherein the durable composite is an aramid plastic fabric.

10. The self-anchoring robot of claim 1, comprising root hairs, wherein the root hairs are resiliently shaped to be biased against the direction of robot pull-out.

11. The self-anchoring robot of claim 1, comprising root hairs, wherein the root hairs comprise a resilient hook shape.

12. The self-anchoring robot of claim 1, comprising root hairs, wherein the root hairs comprise a diameter that is a substantial diameter compared to the main body.

13. The self-anchoring robot of claim 12, wherein the substantial diameter is ½ or more of an everted diameter of the main body.

14. The self-anchoring robot of claim 1, comprising a radially extending body having a larger diameter than the main body and is configured to be inflated via a separate fluid path to increase the outer diameter of the robot after the main body is everted.

15. A method for deploying a self-anchoring everting robot comprising a flexible body tube that accepts fluid and can be everted via pressure to provide tip growth, root hairs on the body tube that model plant roots, the method comprising steps of:
everting into a material a plurality of body tubes or body tube portions with root hairs as shallow hairy branches at an angle to a surface of the material; and
everting a plurality of additional longer body tubes or body tube portions with root hairs vertically and/or at a smaller angle into the surface of the material.

16. The method of claim 15, wherein the self-anchoring everting robot comprises a swellable body, the method further comprising:
pressurizing one or more of the additional longer body tubes or body tube portions.
